(19) United States
(12) Patent Application Publication
(10) Pub. No.: US 2008/0186811 A1
(43) Pub. Date: Aug. 7, 2008

(54) Device And Method For Controlling Disc Runout In An Optical Disc Drive System

(75) Inventor: Coen Adrianus Verschuren, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/816,721

(22) PCT Filed: Feb. 14, 2006
(86) PCT No.: PCT/IB06/50477

§ 371 Date: Aug. 21, 2007

(30) Foreign Application Priority Data
Feb. 28, 2005 (EP) 05101517.0

(51) Int. Cl. G11B 7/00

(52) U.S. Cl. 369/44.14

(57) ABSTRACT

A device for controlling disc runout in an optical disc drive system (10) is described, comprising a rotatable support (12) having a rotation axis (16), the support (12) being arranged to hold a disc (14) such that a normal (18) of the disc (14) is essentially parallel to the rotation axis (16), a tilt means (36) arranged at said support (12) for tilting the disc (14), an optical pickup unit (26) arranged at the optical disc drive (10) for reading information from or writing information on the disc (14), the optical pickup unit (26) having a near field lens arrangement (28), and further comprising a control means (50) for controlling the tilt means (36) by means of a control signal (52) for adjustment of the normal (18) of the disc (14) to minimize the disc runout, wherein the control signal (52) is derived from a far field lens arrangement (38) additionally present in the drive system (10). Further, a method for controlling this runout is described.

The invention relates to a device for controlling a disc runout in an optical disc drive system.

The invention further relates to a method for controlling a disc runout in an optical disc drive system.

An optical disc drive system as mentioned before generally comprises an optical pickup device for writing and/or reading information to and/or from any kind of optical disc-like storage medium, such as CD, DVD or BD. The optical pickup device is moving in a radial direction along the surface of the rotating optical disc.

The optical disc system according to the present invention is a so-called near field optical disc system, the general background of which will be described hereinafter.

A near field optical disc device uses an optical system having a near field lens arrangement, which generally comprises a focusing lens and a solid immersion lens (SIL). A reason for the use of near field optical systems is that the maximum data density that can be recorded on an optical record carrier (in the present application referred to as “disc”) in an optical scanning system inversely scales with the size of the radiation spot that is focused onto the disc. The smaller the spot focused onto the disc the larger the data density that can be recorded on the disc.

The aforementioned spot size in turn is determined by the ratio of the wavelength λ of the optical beam which is focused on the disc, and the numerical aperture (NA) of the focusing lens arrangement used in the optical pickup unit.

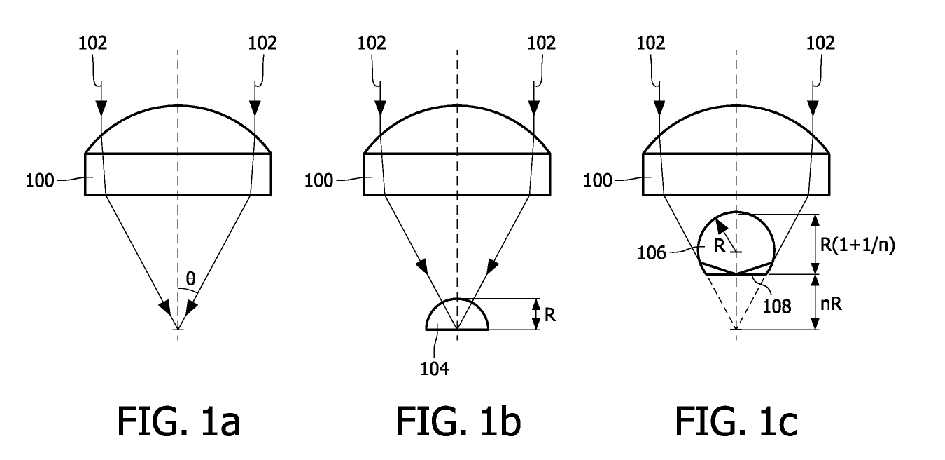

Referring to FIG. 1a) there is shown a focusing lens 100 and an optical scanning beam 102 passing through the lens 100. The NA of the lens 100 is defined as NA=n sin (θ), wherein n is the refractive index of the medium in which the optical beam is focused and θ the half angle of the focused cone of the optical beam in that medium. It is evident that the upper limit for the NA of lenses that focus in air (as it is the case for lens 100 in FIG. 1a) or through a plane parallel plate is unity. A lens like lens 100 is referred to as a far field lens or far field lens arrangement.

The NA of a lens can exceed unity if the light is focused in a high index medium without refraction at the air-medium interface, for example by focusing in the center of a hemispherical solid immersion lens 104 as shown in FIG. 1b). In this case, the effective NA is NA_{eff}=n NA₀, wherein n is the refractive index of the hemispherical solid immersion lens 104, and NA₀ is the NA in air of the focusing lens 100 according to FIG. 1a).

In order to further increase the NA, it is known in the art to use a super-hemispherical solid immersion lens as shown in FIG. 1c). A super-hemispherical lens refracts the optical beam towards the optical axis. Now, the effective NA is NA_{eff}=n² NA₀. The optical thickness of the super-hemispherical solid immersion lens is R (1+1/n), where n is the refractive index of the lens material and R is the radius of the semi-spherical portion of the lens 106.

It is important to note that an effective NA_{eff} larger than unity is only present when the distance from the optical exit face 108 of the solid immersion lens 106 to the disc surface is extremely short. The distance is typically smaller than one tenth of the wavelength of the radiation. The afore-mentioned distance is also called the near field. This short near field means that during writing or reading, an optical disc the distance between the solid immersion lens and the disc must at all times be smaller than a few tens of nanometers.

The afore-mentioned considerations relate to a “first-surface”-case, where the disc does not comprise a cover layer, through which the beam is to be focused onto the information layer.

In case of a disc with a cover-layer, e.g. 3 micrometer in thickness, the spot is not focused on the exit surface of the SIL, but on the data layer below the cover. Thus, the size of the spot at the SIL surface is much larger than the focused spot, e.g. 10 micrometer. As in the first-surface case, the disc-SIL distance needs to be very small to allow efficient coupling of the light into the disc. The difference is that after crossing the air gap, the light can continue to propagate through the cover layer before focusing on the data layer.

The present invention can be used in the first-surface case as well as for the substrate-incident (cover-layer) case, i.e. the near field optical scanning system includes this substrate incident system using evanescent wavecoupling between the SIL (the near field lens in claim 1) and the substrate (medium).

To maintain this very small distance during read and write operations, a dedicated servo system and a suitable gap error signal has to be used. Such a servo system has a limited bandwidth and therefore needs to be designed for a certain allowed residual gap error, typically 2 nm. The required bandwidth to reach this value depends on the rotation speed (for higher speeds it is more difficult to follow any “vertical” disturbance) and the maximum vertical disc displacement (larger displacement is more difficult). Clearly, the maximum vertical displacement should be minimized to allow for the highest rotation speed and therefore also the highest data transfer rates.

It is, therefore, desired that the optical disc is clamped correctly in a predetermined position on the rotatable support of the disc drive system, such that the optical disc is moving in a flat plane during rotation, which plane extends in radial direction with respect to the axis of rotation of the support (for example turntable). Then, the optical pickup unit moves along its radially directed part, whereby the distance between the optical pickup unit and the surface of the optical disc remains the same.

However, there are several reasons why the optical disc may not rotate exactly in that flat radially directed plane. One reason is the possible presence of unwanted particle material on the turntable, so that the clamping means cannot push the optical disc correctly against the surface of the turntable, or incorrect clamping of the optical disc otherwise. In that case, the optical disc will be clamped in a tilting position with respect to the turntable. This may result in an oscillation in axial direction (“vertical disturbance”) of the edge of the optical disc during its rotation and seen from a stationary location, wherein the frequency of the oscillation is equal to the rotational speed (expressed in revolutions per second) of the optical disc.

Another reason can be the inaccuracy or play of the shaft (rotation axis) of the motor, resulting in precession of the axis (this tilt of the record carrier).

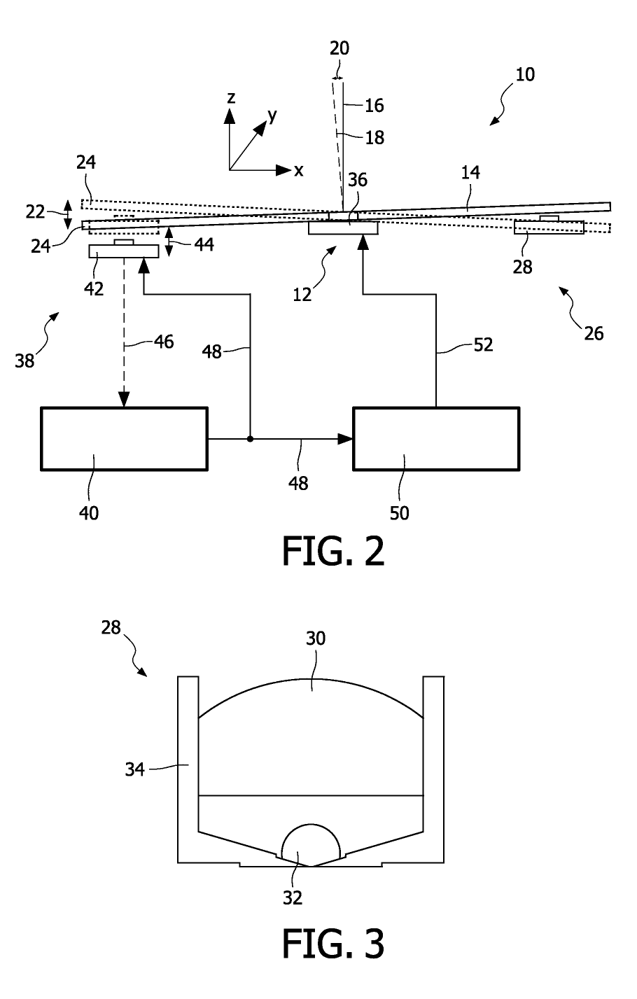

The vertical displacement of the disc, called disc runout, is first of all determined by the flatness of the disc. If the disc is warped or twisted, this leads to large runouts. As an example, silicon wavers of 15 cm (6 inches) diameter have an intrinsic runout better than about 5 μm, whereas polycarbonate discs (for example such as for the known CD and DVD) may have a runout of several hundreds of microns. Secondly, the runout is determined by the disc mounting or clamping mechanism in the drive. If the mount or clamp causes the disc to be slightly tilted with respect to the motor axis, called disc skew (angle of disc normal to motor axis), even a perfectly flat disc will show considerable runout (see FIG. 2). To quantify this effect, an example is given: a perfectly flat 12 cm disc (r=6 cm) with a disc skew of 0.1°(=1.75 mrad) will show a runout as large as 330 μm near its edge. In near field optical disc systems, the disc skew needs to be minimized in order to reach acceptable data transfer rates using a practical focus actuator and servo system for the near field lens arrangement. As an example, an optical disc system, with a realistic bandwidth, is aimed at 1200 rpm (rotations per minute) and has a residual gap error of±2 nm or less. With a well-designed control system and a good actuator, this corresponds to a maximum allowed runout of±10 μm. The result is that for a flat disc with a diameter of 12 cm, the skew should be less than 0.1 mrad or 0.006°.

Purely mechanical solutions are either too large and expensive or not accurate enough. Therefore, there is a need for an automatic disc skew correction method, and also a suitable error signal for the runout is required.

JP 11-016186 discloses an optical pickup device having two objective lenses to cope with optical discs having different substrate thicknesses by recording and reproducing information with the light beam irradiated from one objective lens and detecting the tilt of the optical disc with the light beam irradiated from the other objective lens.

U.S. Pat. No. 5,970,035 discloses an optical disc driving system employing an optical disc as a recording medium. The device includes a skew control mechanism for controlling relative tilt between an optical disc and an objective lens for selectively recording and/or reproducing data on or from a first optical disc having a standard recording density and a second optical disc having a high recording density. The relative tilt between the second optical disc and the objective lens is controlled by the skew control mechanism only when the second optical disc is loaded and data is recorded and/or reproduced on or from the second optical disc.

It is an object of the present invention to provide a device for controlling disc runout in an optical disc drive system using a near field optical pickup unit as well as a method for controlling disc runout in a near field optical disc drive system which is accurate and less expensive.

According to the invention, this object is achieved by a device for controlling disc runout in an optical disc drive system, comprising a rotatable support defining a rotation axis, the support being arranged to hold a disc such that a normal of the disc is essentially parallel to the rotation axis; a tilt means arranged to tilt the disc; an optical pickup unit arranged at the optical disc drive for reading information from or writing information on the disc, the optical pickup unit having a near field lens arrangement, and a control means for controlling the tilt means by means of a control signal for adjustment of the normal of the disc to minimize the disc runout, wherein the control signal is produced by a far field lens arrangement additionally present in the drive unit.

With respect to the method, the object underlying the invention is achieved by a method for controlling disc runout in an optical disc drive system, the drive system comprising a rotatable support defining a rotation axis, the support being arranged to hold a disc such that a normal of the disc is essentially parallel to the rotation axis; a tilt means arranged to tilt the disc; an optical pickup unit arranged at the optical disc drive for reading information from or writing information on the disc, the optical pickup unit having a near field lens arrangement, the method comprising the steps of producing a control signal from a far field lens arrangement additionally present in the drive system, and providing the control signal to the tilt means for adjusting the normal of the disc to minimize the disc runout.

The present invention avoids a time-consuming disc tilt pre-alignment procedure and/or a more accurate clamping mechanism by the fact that the disc skew correction device as well as the disc skew correction method according to the invention uses a control signal for controlling the tilt means which control signal is produced by a far field lens arrangement. The far field lens arrangement is present in addition to the near field lens arrangement which is used to read/write a near field optical disc. Such a far field lens arrangement can already be present in a backward compatible drive which is able to read/write BD or DVD as well as a near field disc. The advantage of using a control signal produced by a far field lens arrangement instead of using the near field focus servo system to generate the runout error signal, is that the far field lens does not need to come into the near field region as it would be the case if the control signal is derived from the near field lens arrangement. Thus, there is no need for an initial accurate alignment of the disc with respect to the far field lens, and thus an accurate pre-alignment and/or a sufficiently accurate clamping mechanism is not required in the device and the method according to the present invention.

Because of the much larger working distance of the far field lens arrangement, focusing on a disc is easy and clamping can be straight forward. Despite this larger distance between the disc and the far field lens arrangement, the sensitivity of the focus error signal and the accuracy of the focus control signal assigned to the far field lens arrangement are sufficient. For example, in DVD systems (laser wave length 650 nm, objective lens NA=0.6), the residual focus error is less than 0.2 μm, and in BD-like systems (laser wave length 405 nm, objective lens NA=0.85) it is correspondingly smaller. These values are much smaller than the maximum allowed disc runout of 10 μm for the near field optical scanning system, so that it is very well possible to reliably minimize the runout to below the required level based on the focus control signals from such far field optical systems.

In the context of the present invention, the tilting means which are arranged to tilt the disc can be designed as tilting means which tilt the support of the disc, but can also be designed as tilting means to tilt the rotating shaft or the motor, for example.

In a preferred embodiment of the device, the control signal is derived from a focus control signal related to a focus error of the far field lens arrangement.

In the method according to the invention, a light beam is focused through the far field lens arrangement on the disc, and a focus control signal is derived from a focus error of the far field lens arrangement, and the focus control signal is input to the control means for disc skew correction.

The advantage here is that the focus control signal which is related to a focus error of the far field lens arrangement exhibits a dependency on the disc runout which is proportional to the axial movement of the disc upon each revolution. This dependency can be advantageously used for controlling the tilt system in order to minimize the disc runout which in turn minimizes the focus control signal.

The invention can be implemented in an optical disc drive system in a very less expensive way, when the device further comprises a focus servo and a focus actuator for the far field lens arrangement.

In the method according to the invention, the focus control signal is preferably generated by a focus servo further input to a focus servo for controlling a focus actuator for the far field lens arrangement.

By virtue of these measures, the optical disc drive system can also be used for reading/writing BD or DVD discs, in which case the far field lens arrangement constitutes the optical pickup unit for these types of discs, and when reading/writing a near field disc, the far field lens arrangement is advantageously used for the disc runout correction.

In a further preferred embodiment, the control signal is a signal having a DC component and an AC component having a periodicity corresponding to the rotation speed of the disc and an amplitude related to the axial movement of the disc, the control means controlling the tilt means in a first and a second direction for minimizing the amplitude.

In this context, it is preferred, if the control means controls the tilt means in an X-direction for minimizing the amplitude, and then controls the tilt means in a substantially perpendicular Y-direction for further minimizing the amplitude, and optionally repeats this procedure.

Accordingly, in the method it is preferred if the tilt means are controlled in a first and a substantially perpendicular second direction for minimizing the amplitude, wherein it is further preferred if the tilt means are controlled in an X-direction for minimizing the amplitude, and the tilt means are controlled in a Y-direction for further minimizing the amplitude, and, optionally, this procedure is repeated, if necessary.

Further advantages will be apparent from the following description and the accompanying drawings.

It is to be understood that the afore-mentioned features and those to be explained below are not only applicable in the combinations given, but also in other combinations or in isolation without departing from the scope of the invention.

An exemplary embodiment of the invention is illustrated in the drawings and will be described hereinafter with reference thereto. In the drawings:

FIG. 1(a) through (c) are schematic diagrams of lens arrangements which can be used in a disc drive;

FIG. 2 is a schematic side view of a disc drive according to the present invention;

FIG. 3 is a schematic diagram of a near field lens arrangement used in the disc drive of FIG. 2;

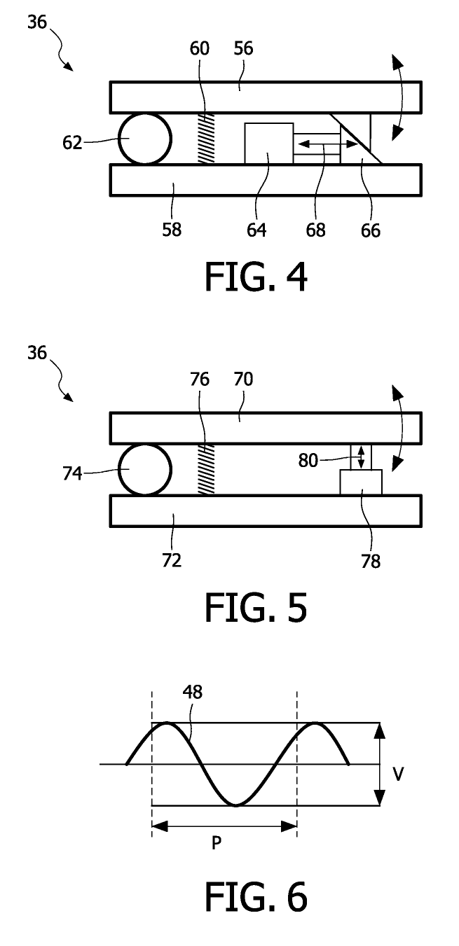

FIG. 4 is a schematic side view of a tilt actuator according to an embodiment of the invention;

FIG. 5 is a schematic side view of a tilt actuator according to another embodiment of the invention; and

FIG. 6 is a diagram of a control signal derived from a far field lens arrangement additionally used in the disc drive of FIG. 2.

FIG. 2 shows an optical disc drive system 10 in a very schematic representation.

The system 10 comprises a rotatable support 12 for supporting or holding a disc 14. The disc 14 is a record carrier from which information is read or on which information is written, when loaded in the disc drive system.

The rotatable support 12 comprises a motor (not shown) defining a rotation or motor axis 16. The support 12 is arranged to hold the disc 14 such that a normal 18 of the disc 14 is essentially parallel to the rotation axis 16.

However, in certain circumstances, for example due to a not accurate mounting of the disc or a not accurate clamping mechanism (not shown) which forms part of the rotatable support, the normal 18 of the disc 14 can be tilted with respect to the rotation axis 16. Such a tilt is often called as disc skew which is labeled with reference numeral 20 in FIG. 2.

The disc skew 20 leads to a considerable vertical movement, referred to as runout at the periphery of the disc 14, as indicated by a double arrow 22. Upon each revolution of the disc 14, the periphery 24 of the disc 14 moves axially between an upper maximum position (indicated by dashed lines in FIG. 2) and a lower maximum position (as indicated by solid lines in FIG. 2). The present invention seeks to minimize such runout as will be described below.

The disc drive system 10 further comprises an optical pickup unit 26 which comprises a near field lens arrangement 28 which is shown in FIG. 3 in more detail.

The near field lens arrangement 28 comprises a first lens 30 and a second lens 32, wherein the second lens 32 is a solid immersion lens (SIL) similar to FIG. 1c). The solid immersion lens 32 and the first lens 30 are arranged in a lens holder 34. The near field lens arrangement 28 is positioned such in the optical pickup unit 26, that the solid immersion lens 32 faces the disc 14 in a very small distance of a few tens of nanometers.

The drive system 12 further comprises a tilt actuator for correcting the disc skew by tilting the disc 14 such that the disc skew 20 and thereby the runout 22 is minimized.

In order to provide an appropriate control signal for the tilt actuator 36, the disc drive system further comprises a far field lens arrangement 38 which comprises a lens as shown in FIG. 1a), for example. “Far field lens arrangement” here means that light passed through the far field lens arrangement is focused in air (or through the cover-layer) on the disc 14 similar to FIG. 1a, which is different from the near field lens arrangement 28 which focuses light on the optical axis at the exit face of the solid immersion lens 32 (or through the cover-layer) similar to FIG. 1b or 1c, so that light is coupled to the disc 14 by evanescent coupling. The far field lens arrangement has a larger distance from the disc 14 than the near field lens arrangement 28.

The disc drive system further comprises a focus servo 40 for the far field lens arrangement 38 and a far field focus actuator for moving the far field lens arrangement 38 due to a double arrow 44.

Light (not shown) passing through the far field lens arrangement 38 is focused on the disc 14. A focus error signal 46 is input to the focus servo which generates a focus control signal 48 which is input to the focus actuator 42 of the far field lens arrangement.

The focus control signal 48 is also used as a control signal for controlling the tilt actuator 36. To this end, the focus control signal 48 is fed into a disc skew correction circuit 50 which produces a control signal 52 for controlling the tilt actuator 36, which in turn tilts the disc 14 in order to minimize the disc skew 20 and thereby the disc runout 22.

The disc 14 is typically a near field disc so that the optical pickup unit 26 with the near field lens arrangement 28 reads information from the disc 14 or writes information on the disc 14. On the other hand, the far field lens arrangement 38 can be used for reading information from or writing information on other types of discs 14, for example a DVD or BD, so that the disc drive unit 10 can be used for reading or writing a variety of disc types.

The focus control signal 48 produced by the focus servo 40 is a direct measure of the runout 22 and exhibits a periodic course as shown in FIG. 6. “P” denotes the period of the focus control signal 48 which has, as shown in FIG. 6, an AC component, the amplitude “V” of which is a direct measure of the disc runout 22. When the tilt actuator 36 adjusts the disc normal 18 to be essentially parallel to the rotation axis 16, the amplitude of the signal 48 is also minimized.

The tilt actuator 36 or “skew correction head” 36 used in the present invention can be arranged for modifying the tilting of the disc 14 in X and Y direction, as indicated by a coordinate system in FIG. 2. An electrically controlled tilt actuator or skew correction head 36 can be based on a variety of principles, e.g. electromagnetic, piezo-electric. All these principles can be used to provide an electrically controlled tilting action.

FIGS. 4 and 5 show examples of principles of the tilting mechanism provided by the tilt actuator 36.

FIG. 4 schematically shows an embodiment of the tilt actuator 36 using a lever-type tilting mechanism. The tilt actuator 36 comprises a top plate 56 on which the disc 14 can be positioned. The motor for rotating the disc 14 is attached to a bottom plate 58. The plate 56 and 58 are kept together by a spring 60 and can rotate over a ball joint 62. The tilting action is performed by an electrically controlled device 64 such as a motor, an electro-magnetic or a piezo-electric actuator that drives a wedge 66 attached to a linear shaft 68. Movements of the wedge 66 will cause the top plate 56 to tilt with respect to the bottom plate 58.

Another embodiment of the tilt actuator 36 is shown in FIG. 5, comprising a top plate 70, a bottom plate 72, a ball joint 74, a spring 76 similar or identical to the embodiment of FIG. 4. An electrically controlled device 78 directly drives a shaft 80 against the top plate 70 to provide the tilting action.

It is to be understood that the farfield lens arrangement 38 may be a separate optical pickup unit in the optical disc drive system, but may also be integrated in the optical pickup unit having the near-field arrangement.

In the previous description, tilt means have been described to tilt the support and thereby the disc. Other arrangements can be met, for example a tilt means for tilting the rotating shaft of the motor or the motor itself.

1. A device for controlling disc runout in an optical disc drive system (10), comprising:
a rotatable support (12) defining a rotation axis (16), the support (12) being arranged to hold a disc (14) such that a normal (18) of the disc is essentially parallel to the rotation axis (16);
a tilt means (36) arranged to tilt the disc (14);
an optical pickup unit (26) arranged at the optical disc drive for reading information from or writing information on the disc (14), the optical pickup unit (26) having a near field lens arrangement (28), and
a control means (50) for controlling the tilt means (36) by means of a control signal (52) for adjustment of the normal (18) of the disc (14) to minimize the disc runout, wherein the control signal (52) is derived from a far field lens arrangement (38) additionally present in the drive system (10).

2. The device of claim 1, wherein the control signal (52) is derived from a focus control signal (48) related to a focus error of the far field lens arrangement (38).

3. The device of claim 2 further comprising a focus servo (40) and a focus actuator (42) for the far field lens arrangement (38).

4. The device of claim 1, wherein the control signal (52) is a signal having a DC component and an AC component having a periodicity corresponding to a rotation speed of the disc (14) and an amplitude (V) related to a distance between the far field lens arrangement (38) and the disc (14), the control means (50) controlling the tilt means (36) in a first and a second direction for minimizing the amplitude (V).

5. The device of claim 4, wherein the control means (50) controls the tilt means (36) in an X-direction for minimizing the amplitude (V), and then controls the tilt means (36) in a Y-direction for further minimizing the amplitude (V), and optionally repeats this procedure.

6. A method for controlling disc runout in an optical disc drive system, the drive system comprising:
a rotatable support (12) defining a rotation axis (16), the support (12) being arranged to hold a disc (14) such that a normal (18) of the disc (14) is essentially parallel to the rotation axis (16);
a tilt means (36) arranged to tilt the disc (14);
an optical pickup unit (26) arranged at the optical disc drive for reading information from or writing information on the disc (14), the optical pickup unit (26) having a near field lens arrangement (28),
wherein the method comprises the steps of:
deriving a control signal (52) from a far field lens arrangement (38) additionally present in drive system (10), and providing the control signal (52) to the tilt means (36) for adjusting the normal (18) of the disc (14) to minimize the disc runout.

7. The method of claim 6, wherein a light beam is focused through the far field lens arrangement (38) on the disc (14), and a focus control signal (48) is derived from a focus error of the far field lens arrangement (38), and the focus control signal (48) is used as input to the control means (50).

8. The method of claim 7, wherein the focus control signal is generated by a focus servo (40) and further input to a focus actuator (42) for the far field lens arrangement (38).

9. The method of claim 6, wherein the control signal (52) is a signal having a DC component and an AC component having a periodicity corresponding to a rotation speed of the disc (14) and an amplitude (V) related to a distance between the far field lens arrangement (38) and the disc (14), the method further comprising controlling the tilt means (36) in a first and a second direction for minimizing the amplitude (V).

10. The method of claim 9, wherein the tilt means (36) are controlled in an X-direction for minimizing the amplitude (V), and the tilt means (36) are controlled in a Y-direction for further minimizing the amplitude (V), and, optionally, this procedure is repeated.

11. An optical scanning system comprising a device according to claim 1.

12. An optical scanning system adapted to use a method according to claim 6.
